(19) United States
(12) Patent Application Publication
(10) Pub. No.: US 2005/0166260 A1
(43) Pub. Date: Jul. 28, 2005

(54) Distributed policy enforcement using a distributed directory

(76) Inventors: Christopher Betts, Mount Dandenong (AU); Tony Rogers, Rowville (AU)

Correspondence Address: Cooper & Dunham LLP, 1185 Avenue of the Americas, New York, NY, 10036, US

(21) Appl. No.: 10/888,903

(22) Filed: Jul. 9, 2004

Related U.S. Application Data
(60) Provisional application No. 60/486,594, filed on Jul. 11, 2003.

(51) Int. Cl. H04L 9/32

(52) U.S. Cl. 726/4; 713/189

(57) ABSTRACT

A method for managing access to a resource includes receiving a request for access to the resource, obtaining data pertinent to the request from a directory, generating an authorization decision for the request based on the obtained data, and allowing access to the resource when the generated decision is to allow access.

### REFERENCE TO RELATED APPLICATION

The present disclosure is based on provisional application Ser. No. 60/486,594, filed Jul. 11, 2003, the entire contents of which are herein incorporated by reference.

### BACKGROUND

1. Technical Field

The present disclosure relates to distributed policy enforcement and, more specifically, to distributed policy enforcement using a distributed directory service.

2. Description of the Related Art

Computers are frequently utilized to manage sensitive data. Computers should therefore be able to effectively authenticate users and limit user access to systems, features and information that the user is authorized to access. It is often desirable for system managers to control access to each system, feature and item of information (resources) using a set of standards uniquely tailored to the security requirements of that particular resource. Each resource so controlled forms a point of enforcement whereby a user has to satisfy particular rules and/or policies to access the controlled resource.

Managing access control is an especially complex task for large enterprises that may have a large number of users located world-wide and may have a large number of points of enforcement all with unique security requirements.

Managing access control has traditionally been a very difficult task often requiring that computer programs be custom tailored to reflect the security policies and rules of the enterprise. For this reason many enterprises are left using one-size-fits-all security features that may be pre-programmed into the hardware and software products that form a particular controlled resource. These security features often have limited potential for customization.

Customization of security features often involves professional computer programming that can be very expensive. This expense may be exacerbated by the great number of controlled resources an enterprise may have and the fact that each controlled resource may employ a different means of control that should be uniquely customized to reflect the security policies and rules.

Enterprises may wish to apply a standard set of security policies and rules to each controlled resource and/or may wish to utilize a standard language to express security policies and rules for all controlled resources. Enterprises may additionally desire to be able to quickly and easily modify rules and policies and have these modifications applied quickly and uniformly to the appropriate points of enforcement.

Standards have been adopted to facilitate the managing of access control. By utilizing a standardized language for the managing of access control, a single set of rules and policies may be easily written or modified and applied to every controlled resource that utilizes the standardized language eliminating the need for having to individually customize each controlled resource.

XML Access Control Markup Language (XACML) is an emerging standard that defines how controlled resources may be accessed by users and provides a standard language for expressing security policies and rules. The XAXML standard is maintained by the Organization for the Advancement of Structured Information Standards (OASIS). XACML is therefore an example of a standard that may be adopted to facilitate the managing of access control.

FIG. 1 is a block diagram showing an example of how XAXML may be used to control access to resources. XACML utilizes Policy Enforcement Points (PEPs) 102. A PEP acts as a gatekeeper to a restricted resource 104, either permitting or denying access 103 to the restricted resource 104 by the user 100 requesting access 101.

PEPs 102 may contact 105 Policy Decision Points (PDPs) 108 to determine whether a particular user should be permitted or denied access 103 to a particular resource 104. The PDP 108 may then generate an authorization decision 106 based on the security policies and rules 107 that have been adopted by the enterprise along with external data 109 such as user data and user privileges (collectively referred to as pertinent data). The security policies and rules 107 may be stored in a remote location that is accessible over a network 110. Alternatively, security policies and rules 107 may be replicated and distributed to a location local to the PDP 108 from a central server that communicates with the PDP 108 over network 110.

It is common, especially among large enterprises, to have multiple PEPs 102 and PDPs 108. This allows a large number of users world-wide to quickly be authenticated at the same time regardless of their location and the location of the restricted resource 104. However distributing security policies and rules 107 to all points of enforcement may constitute a large-scale deployment. Therefore, distributing security policies and rules 107 securely and in a timely fashion represents a significant problem for enterprises. Problems emerge such as whether to distribute a single large global policy file to every PDP 108 or to only distribute different parts of the file to different PDPs 108. Where different PDPs 108 receive policy updates at different times, contention might emerge between the various PDPs 108. Additionally, if a PDP 108 is temporarily unreachable when an update is distributed, it might be a long time before the new updates are implemented on that PDP 108.

Once policy updates have been distributed to the various PDPs 108, requests for access should generally be considered in light of external data 109 such as, for example, user data, user privileges, resource status, etc. This reliance on external data 109 can make authentication more difficult and/or time consuming. The external data 109 may be made available to the PDP 108 over a network 111. This external data 109 is generally not distributed to ensure integrity. For example, a user who has previously had a high security privilege may have that privilege revoked. It is then critical that the latest user privilege data be accessible to the PDP 108. If this data is not immediately distributed enterprise-wide, the security risks can be severe.

The XACML standard has not determined how policies and data are to be replicated and distributed between PDPs. Therefore, replication and distribution remains an inherently difficult problem.

It is desirable to have a way of quickly and securely managing distribution of security policy and rules to PDPs along with the necessary data required by the PDPs to use the rules and policies to make an authorization decision.

### SUMMARY

A method for managing access to a resource includes receiving a request for access to the resource, obtaining data pertinent to the request from a directory, generating an authorization decision for the request based on the obtained data, and allowing access to the resource when the generated decision is to allow access.

A system for managing access to a resource includes one or more PEPs for receiving requests for access to the resource, one or more PDPs for obtaining data pertinent to the request generating a decision based on the obtained data, and a directory for providing the one or more PDPs with access to the data pertinent to the request. The PEP uses the received request to generate a PDP request, sends the generated PDP request to one of the one or more PDPs, receives an authorization decision from the one of the one or more PDPs, and allows access to the resource when the received authorization decision is to allow access.

A computer system includes a processor and a program storage device readable by the computer system, embodying a program of instructions executable by the processor to perform method steps for managing access to a resource. The method includes receiving a request for access to the resource, obtaining data pertinent to the request from a directory, generating an authorization decision for the request based on the obtained data, and allowing access to the resource when the generated decision is to allow access.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a block diagram showing how XAXML may be used to control access to resources;

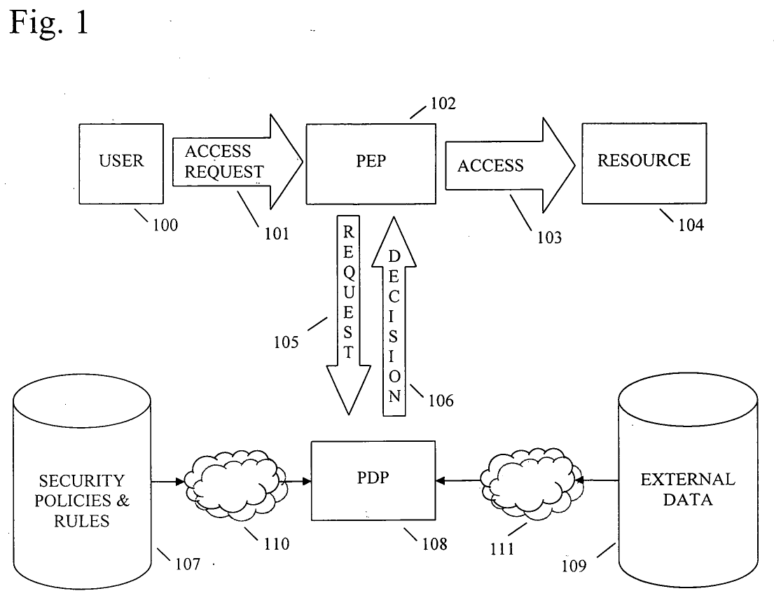

FIG. 2 is a block diagram showing how a distributed directory service may be used to store and make pertinent data available to an XAXML access control system according to embodiments of the present disclosure;

FIG. 3 is a block diagram showing how multiple PEPs may be used to provide multiple decisions for multiple requests according to embodiments of the present disclosure;

FIG. 4 is a block diagram showing a combined PEP and PDP according to an embodiment of the present disclosure;

FIG. 5 is a flow chart showing how access control may be effectively and securely managed by using a distributed directory service to store and make available pertinent data that can be used to generate authorization decisions according to an embodiment of the present disclosure; and

FIG. 6 is a block diagram showing an example of a computer system capable of implementing the method and apparatus according to embodiments of the present disclosure.

### DETAILED DESCRIPTION

In describing preferred embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

According to an embodiment of the present disclosure, access control may be effectively and securely managed by using a distributed directory service to store and make available user data, security policy, and rules (pertinent data) that can be used to generate authorization decisions. By using a distributed directory service to store and make available security policies and rules, replication and distribution of security policies and rules is established along with other useful advantages. By storing security policies and rules together with user data, the process of generating authorization decisions may be greatly simplified.

A directory is a specialized database that is primarily used for allowing a large number of users to quickly look up information. A directory is not intended to be primarily used as a tool for the organization and storage of data and is therefore optimized for information retrieval and not necessarily information storage. A directory service is a computer application that allows for access to a directory: While some directory services are local and only allow for use on a particular computer network, other directory services are global and allow for general access over a global computer network such as the internet.

Global directory services may spread information across multiple computer servers all of which cooperate to provide directory service. Such directory services are known as distributed directory services. The Internet Domain Name System (DNS) is an example of a globally distributed directory service. The DNS allows computers connected to the internet to look up the numeric internet address from the corresponding internet domain name.

X.500 is a common set of standards covering distributed directory services. Lightweight Directory Access Protocol (LDAP), is a protocol for quickly and easily accessing distributed directory services. LDAPs are commonly used in association with X.500 directories. LDAPs communicate using TCP/IP transfer services or similar transfer services making LDAPs well suited for use over the internet or private company intranets.

LDAP directories can be hierarchically arranged for more efficient searching. For example, an LDAP directory tree using domain-based naming might begin with a .com, org and .gov objects at the top level of the hierarchy. Within each top level object may be a series of objects representing organizations, and within each of these objects may be a series of objects representing users. Hierarchical objects are commonly referred to as parent object and child object depending on their relationship to one another. For example, an object representing a printer may be the child of an object representing a computer in the case where the printer is connected to the computer.

The hierarchical nature of the distributed directory service, for example, the LDAP, may allow for the simple mapping of security policies and rules onto the directory structure. This is because XACML policy may be expressed largely in terms of XACML policy attributes and XACML policy attributes values. These policy attributes and policy attribute values are evaluated in light of combining algorithms that may be described using XACML. These attributes and attribute values may be mapped straight to directory attributes and directory attribute values that are part of the LDAP. The combining algorithms may often be mapped to simple directory search queries that are part of the LDAP.

LDAP directory services are commonly based on a client-server model. While one or more LDAP servers contain the LDAP data, a client is launched by a person seeking to access LDAP directory data. The client connects to the server and communicates the search criteria. The server then communicates the search results to the client. The client communicates the search results to the user. This client server model is well suited for application to policy enforcement management such as XACML where PEPs (corresponding to clients) are used to request decisions from PDPs (corresponding to servers).

One common example of an LDAP directory service is a list of names and email addresses that allows an email client to resolve an email address of a contact when the contact's name is supplied.

Because many directory services, such as LDAP directory services are distributed, issues involving replication and distribution of data have been resolved with respect to LDAP directory services. LDAP directory services are able to quickly and securely distribute directory data so that the same version of data may always be accessible from any of the servers which provide the directory services.

Distributed directory services, for example LDAPs, provide a wide variety of other useful features to enhance reliability and security of data distribution. Some examples of these other useful techniques are described below.

By using a distributed directory service, such as an LDAP, to store and make available security policies and rules, replication and distribution of security policies and rules and user data may be automatically handled at the directory layer. This is because the directory already manages security, distribution, fail over, load balancing and handles many other problems that beset distribution. Additionally, by storing all pertinent information within the directory, the PDP need not access external data thereby making authentication more reliable and secure.

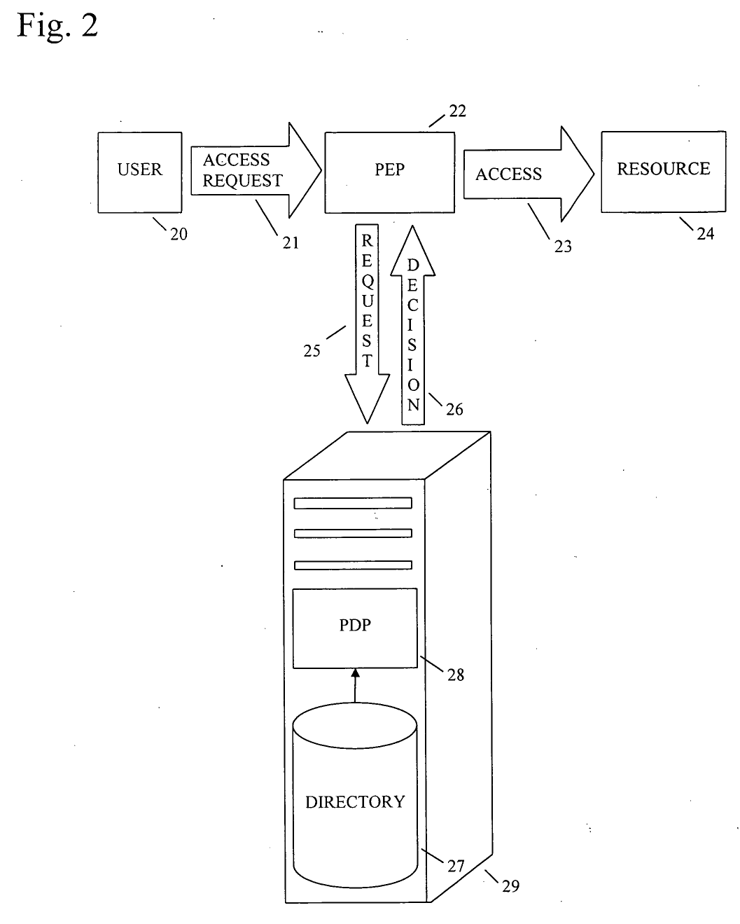

FIG. 2 is a block diagram showing how a distributed directory service may be used to store and make available security policies and rules to an XAXML access control system. A user 20 seeking to gain access 23 to a resource 24 may generate an access request 21. The access request 21 may be sent to a PEP 22. The PEP may request 25 a PDP 28 to determine whether the particular user 20 should be permitted or denied access 23 to the resource 24.

The PDP 28 may generate its decision on whether to grant access based on pertinent data that may be made available via the distributed directory service 27. Such data might include user data, such as user names, passwords and user privileges. Such data might additionally include security policies and rules.

According to an embodiment of the present disclosure, the PDP 28 and the distributed directory service 27 may both operate from a common server 29. By placing the PDP 28 and the distributed directory service 27 on the same server 29, the PDP 28 can quickly and securely gain access to the pertinent information to determine whether to grant access.

The PDP 28 may generate a decision 26 on whether to grant access and provide that decision 26 to the PEP 22. When the decision 26 generated is to allow access 23, access 23 to the resource 24 may be granted to the user 20.

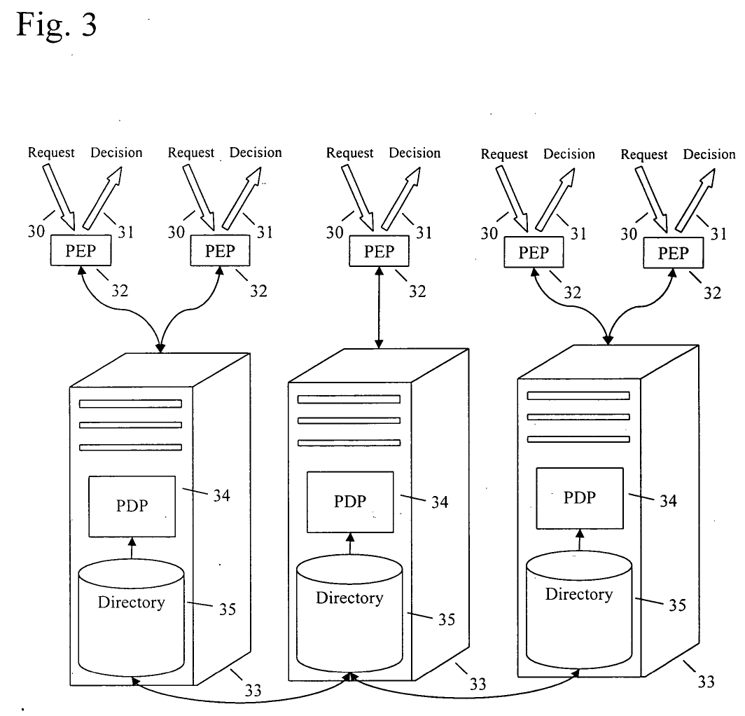

An enterprise may have a large number of PEPs to conveniently accommodate the large number of points of enforcement that the enterprise may have. FIG. 3 is a block diagram showing how multiple PEPs 32 may be used to provide multiple decisions 31 for multiple requests 30 according to embodiments of the present disclosure.

Each PDP 34 may serve multiple PEPs 32. For example, there may be one PDP 34 at each subnet of the computer network. Each PDP 34 may then rely on a distributed directory service 35 that is located within a server 33 that contains the PDP 34.

In addition to providing effective and secure distribution of pertinant information, the distributed directory service may provide other advantages that are typical of distributed directory services. For example, the distributed directory service may provide load balancing.

Load balancing involves using more than one server to run the same distributed directory service. Access requests (load) may then be spread among multiple servers all working towards processing directory service requests by using distributed scheduling algorithms to allocate requests among the available servers.

In an embodiment of the present disclosure, requests for pertinent information made by a PDP to the distributed directory service may be load balanced. If the local distributed directory service has high load, the information request may be handled by the distributed directory service on another server. This may help prevent slowdowns related to multiple PDP requests to the same distributed directory service.

Distributed directory services may provide failover. A failover is a redundant or standby server that can automatically take over for the primary server in the event the primary server fails. Failover servers may be referred to as “hot standby” or “warm standby” servers. The use of a failover allows for a directory service to continue handling requests even in the event of a server malfunction, for example, the failover server (secondary server) may take over for the primary server when excess load causes the primary server to fail. However, the usefulness of the failover server is not limited to handling problems associated with excess load. Failovers may be used to ensure the continued offering of directory services in any number of circumstances that may render the primary server non-functional.

Where a distributed directory service is not properly functioning, distributed directory services may provide a hot standby server for providing the required information.

Due presumably to the difficulty of creating a secure distribution, the original XACML specification imagines a large number of PEP enforcement points communicating with a small (possibly even a single) PDP decision point. Using a distributed directory service as the basis for XACML, however, may make it possible to use any number of PDPs, potentially one PDP for every PEP. It may then even be possible to combine the PDP and PEP within a single server.

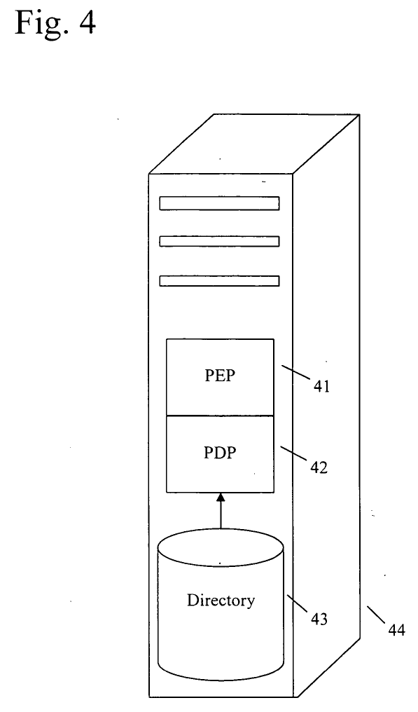

FIG. 4 is a block diagram showing a combined PEP 41 and PDP 42 according to an embodiment of the present disclosure. Due to the ease of replication and distribution of the directory utilized in embodiments of the present disclosure, it may be possible to combine the PEP 41 and the PDP 42 in the same servers 44 that host the distributed directory services 43. This combination may greatly simplify the architecture of the XACML system and greatly improve the speed of the server response since calls between the PDP 42 and the PEP 41 are being made on the same machine.

Where the PDP and PEP have been so combined, it may still be useful to retain the external XACML interfaces for the PDP and PEP to maintain as much XACML compliance as possible.

It may even be possible to combine a policy administration point (PAP) into the same distributed directory service to further simplify the architecture of the XAXML system. A PAP may be used for the administration of pertinent data, for example security policies and rules.

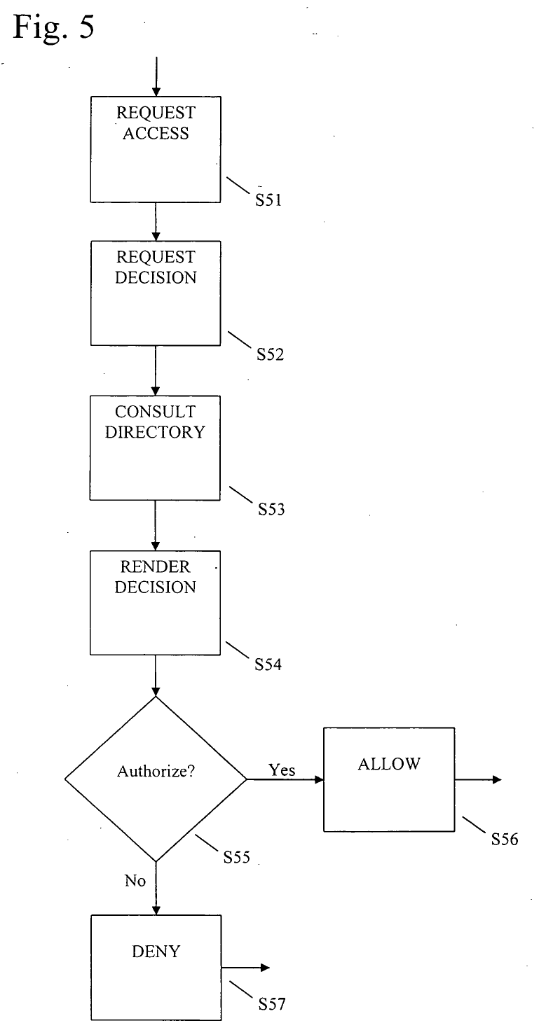

FIG. 5 is a flow chart showing how access control may be effectively and securely managed by using a distributed directory service to store and make available security policies and rules that can be used to generate authorization decisions according to an embodiment of the present disclosure.

First a user may request access to a resource (Step S51). A PEP may receive this request and then request that a decision be made by a PDP (Step S52). The PDP may utilize stored data that is pertinant to rendering the decision. The PDP may access this pertinant data using a distributed directory service, one distribution of which may be located on the same server as the PDP (Step S53). The PDP may then use the pertinant information to generate a decision as to whether to allow or deny the user access to the requested resource (Step S54). This decision may be sent to the PEP. If the decision is to allow the access (Yes Step S55) then the PEP may provide the user with access to the resource (Step S56). Access may continue for a predetermined length of time or for as long as particular use of the resource continues. If the decision is to deny the access (No Step S55) then the PEP may deny the user access to the resource (Step S57).

Universal Description, Discovery and Integration (UDDI) standards have been adopted to facilitate the discovery and integration of web based applications called web services. Users can use UDDI to find the location of web services, in a manner similar to looking for businesses in a yellow pages phone book. UDDI repositories generally are provided as directories in which information pertaining to an enterprise, its services, technical information, and information about specifications for the enterprise's web services can be looked up.

Many enterprises maintain UDDI repositories that utilize distributed directory services such as LDAP. Embodiments of the present disclosure may allow for an enterprise to use a UDDI repository, for example a UDDI repository that is already functioning on the enterprises network, as the servers that host the PDP and distributed directory services as described above. By combining a UDDI repository with the servers that host the PDP and distributed directory services, policy enforcement may be less costly, simpler, and more secure.

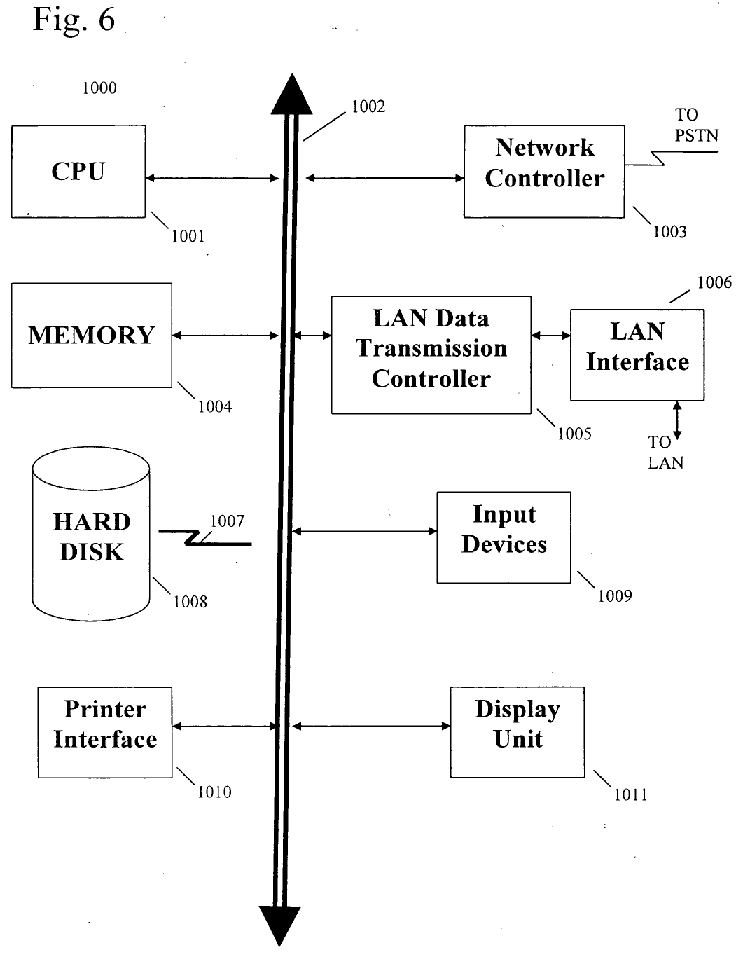

FIG. 6 shows an example of a computer system which may implement the method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal buss 1002, and one or more input devices 1009, for example, a keyboard, mouse etc. As shown, the system 1000 may be connected to a data storage device, for example, a hard disk, 1008 via a link 1002.

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

1. A method for managing access to a resource, comprising:
receiving a request for access to the resource;
obtaining data pertinent to the request from a directory;
generating an authorization decision for the request based on the obtained data; and
allowing access to the resource when the generated decision is to allow access.

2. The method of claim 1, wherein said method utilizes one or more XACML standards.

3. The method of claim 1, wherein the directory is an X.500 directory.

4. The method of claim 1, wherein obtaining data pertinent to the request from a directory comprises looking up the data using a distributed directory service.

5. The method of claim 4, wherein the distributed directory service provides for load balancing.

6. The method of claim 4, wherein the distributed directory service provides for a failover.

7. The method of claim 4, wherein said distributed directory service is an LDAP.

8. The method of claim 1, wherein the data pertinent to the request comprises security policy and rules.

9. The method of claim 1, wherein the data pertinent to the request comprises user data and privileges.

10. A system for managing access to a resource, comprising:
one or more PEPs for receiving requests for access to the resource;
one or more PDPs for obtaining data pertinent to the request generating a decision based on the obtained data; and
a directory for providing the one or more PDPs with access to the data pertinent to the request;
wherein the PEP:
uses the received request to generate a PDP request;
sends the generated PDP request to one of the one or more PDPs;
receives an authorization decision from the one of the one or more PDPs; and
allows access to the resource when the received authorization decision is to allow access.

11. The system of claim 10, wherein said system utilizes one or more XACML standards.

12. The system of claim 10, wherein the directory is an X.500 directory.

13. The system of claim 10, wherein the directory provides the one or more PDPs with access to the data pertinent to the request through a distributed directory service.

14. The system of claim 13, wherein the distributed directory service provides for load balancing.

15. The system of claim 13, wherein the distributed directory service provides for a failover.

16. The system of claim 13, wherein said distributed directory service is an LDAP.

17. The system of claim 10, wherein the data pertinent to the request comprises security policy and rules.

18. The system of claim 10, wherein the data pertinent to the request comprises user data and privileges.

19. The system of claim 10 wherein each of the one or more PDPs are executed in a server along with a client for the distributed directory service.

20. The system of claim 10 wherein each of the one or more PDPs are executed in a server along with a client for the distributed directory service and one of the one or more PEPs.

21. A computer system comprising:
a processor; and
a program storage device readable by the computer system, embodying a program of instructions executable by the processor to perform method steps for managing access to a resource, the method comprising:
receiving a request for access to the resource;
obtaining data pertinent to the request from a directory;
generating an authorization decision for the request based on the obtained data; and
allowing access to the resource when the generated decision is to allow access.

22. The computer system of claim 21, wherein said method utilizes one or more XACML standards.

23. The computer system of claim 21, wherein the directory is an X.500 directory.

24. The computer system of claim 21, wherein obtaining data pertinent to the request from a directory comprises looking up the data using a distributed directory service.

25. The computer system of claim 24, wherein the distributed directory service provides for load balancing.

26. The computer system of claim 24, wherein the distributed directory service provides for a failover.

27. The computer system of claim 24, wherein said distributed directory service is an LDAP.

28. The computer system of claim 21, wherein the data pertinent to the request comprises security policy and rules.

29. The computer system of claim 21, wherein the data pertinent to the request comprises user data and privileges.
